(19) United States
(12) Patent Application Publication
(10) Pub. No.: US 2015/0042811 A1
(43) Pub. Date: Feb. 12, 2015

(54) Monitoring Beacon

(71) Applicants: Bruno Avignon, Buc (FR); Lionel Thomas, Le Perray En Yvelines (FR)

(72) Inventors: Bruno Avignon, Buc (FR); Lionel Thomas, Le Perray En Yvelines (FR)

(21) Appl. No.: 14/385,938

(22) PCT Filed: Mar. 22, 2012
(86) PCT No.: PCT/IB2012/000579

§ 371 Date: Sep. 17, 2014

(51) Int. Cl. H04N 7/18; G08B 21/22; G08B 21/02

(52) U.S. Cl. CPC H04N 7/183; G08B 21/0297; G08B 21/22
USPC 348/152

(57) ABSTRACT

A monitoring beacon which includes a ground base into which a telescopic mast is inserted. An intrusion detection and identification head is mounted on one end of said mast. The beacon also has solar panel support structures mounted pivotably on the ground base. During transport, the panel support structures are raised to form a protective cage around the beacon, while during use, the panel support structures are folded down flat around the base so that the mast and its detection head are no longer enclosed.

### FIELD OF THE INVENTION

The invention concerns a monitoring beacon for intrusion detection. The beacons are advantageously placed within a network in which they are designed to communicate with each other and with a central monitoring unit.

### BACKGROUND OF THE INVENTION

This type of surveillance system can be used in numerous applications such as border control in an open, unfenced area, industrial facilities and building construction sites.

### SUMMARY OF THE INVENTION

The invention is aimed at offering a new type of monitoring beacon designed to provide discreet but efficient surveillance, particularly when used in a border control surveillance system which must be installed in such a way that it cannot be detected by potential intruders. It must also be modular so that its configuration can be regularly and rapidly changed to surprise said potential intruders.

The invention thus includes a monitoring beacon to detect intrusion which comprises a ground base into which a telescopic mast with a detection head on one end is inserted. Solar panel support structures are mounted pivotably on the base, so that the beacon can be placed either in transport position, where the support structures are raised to form a protective cage, or in operating position, where the support structures are folded down flat around the base so that the mast and its detection head are no longer enclosed.

Thus, each of the beacons in a given monitoring network can be placed either in transport position in which the detection head is protected by a protective cage or in operating position in which the solar panels are folded down so that the beacon will have its own power supply when exposed to light. It is understood that the transition from one position to the other is easily achieved by manipulating the support structures, a particularly interesting feature when said beacon is used in a modular, rapid-deployment monitoring system.

According to particularly advantageous additional features, the beacon in the invention comprises communication equipment designed to interact with a monitoring unit. Said communication equipment comprises in particular a mobile directional antenna with a high electromagnetic gain which is mounted on the telescopic mast by means of a turret mounted rotationally around the axis of deployment of the mast. The head is hinged to the end of the mast, independently of rotation of the mobile antenna. Thus, if an intruder is detected, the antenna can be directed towards the monitoring unit when the beacon is in operating position, independently of the direction of the head which continues to target potential intruders. The mobile antenna is also designed to be extended alongside the telescopic mast, and housing is provided in the ground base to take part of the antenna when the mast is retracted. The antenna can thus be retracted as much as possible to facilitate handling when the beacon is in transport position.

In a preferred construction method for reduction to practice, a fixed antenna, which projects vertically beyond the base next to the mast, forms communication equipment that is distinct from that formed by the mobile antenna, with the fixed antenna designed for continuous transmission and reception of low bandwidth data while the mobile antenna is only activated according to said data to transmit high bandwidth data. This means that the mobile antenna which is designed for high bandwidth transmission does not receive a continuous power supply, thus increasing the autonomy of the beacon's power supply.

According to a secondary feature of the invention, the legs are hinged to the base so that the beacon is not resting on the ground via the bottom of the base only, thus increasing the stability of the base. The legs comprise an adjustable rod so that the horizontal level of the base can be adjusted. Adjusting the horizontal level means that the detection and identification head can cover the surrounding area with a flat, panoramic movement. Furthermore, this prevents sun from being reflected on the detector plates and making the beacon detectable.

According to a characteristic of the invention, each element of the support structure has a cover plate. In the beacon operating position, the solar panels are placed on top of the support structure with the cover plates underneath. In the beacon transport position, the solar panels are facing towards the beacon and the cover plates are facing away from the beacon. The cover plates are thus used as fairing when the beacon is in transport position, which means that the beacon can be handled and transported without any risk of damaging either its internal components or the solar panels. Said cover plates are underneath the solar panels when they are exposed to the sun, so that the plates do not interfere with solar energy capture.

According to a characteristic of the invention, the solar panels are stacked on two opposite sides of the beacon and the support structure on these two sides comprises arms that can be opened up on either side of the structure when it is folded up, to provide a support for each of the panels after unstacking. The surface area of the panels can thus be increased and the beacon's autonomy increased when it is in operating position, without having to increase the volume of the beacon when it is in transport position.

According to another characteristic of the invention, the support structures on the opposite sides of the beacon have a hinged flap on the end opposite the base which forms a strut when the support structure is folded down and is part of the top of the protective cage when the support structure is raised.

As a result of the different characteristics of the invention as mentioned above and described in detail below, the monitoring beacon according to the invention is thus an autonomous robot in terms of power supply and data processing, incorporated into a communication network simulating and optimizing the behavior of a human sentinel.

The invention also concerns a network of video surveillance beacons as described above whose head contains a video camera and an intense lighting device similar in intensity to a photographic flash, with the particular feature that, in order to identify an intruder in a given area, the camera in one of the beacons is used at the same time as the lighting device in another beacon, with both beacon heads being directed towards the area concerned. Thus, the beacon's capabilities are pooled when the beacon detects an intruder under low visibility conditions such as night-time or fog. The optical effect of active imaging is reproduced without the added complexity of ultra-precise time synchronization of the light source. The video produced by the camera which is also built into the detection and identification head can be used to identify the intruder despite its lower resolution, and, in particular, to obtain information on the subject's behavior.

Other features and advantages of the invention will become obvious from the following description of one of its embodiments, illustrated by:

### BRIEF DESCRIPTION OF THE DRAWINGS

FIG. 1 is a perspective view of the monitoring beacon according to the invention in closed position;

FIG. 2 is a view, similar to that of FIG. 1, of the beacon in transport position, with the cover plates cut away to reveal the first of the three solar panels stacked and housed under the cover plate;

FIG. 3 is a view, similar to that of FIGS. 1 and 2, this time with the three stacked solar panels cut away so that the telescopic mast, the antennas and the detection head can be seen;

FIG. 4 is a perspective view, seen from below, of the beacon in its operating position;

FIG. 5 is a perspective view, seen from above, of the beacon in its operating position;

FIGS. 6 and 7 are views of the telescopic mast and its mobile antenna, with and without the detection head; and

FIG. 8 is a bird's eye view showing the mast and base of the beacon, without the solar panel support structure. Here the cover on the base has been cut away to show the electronic components present in the ground base and represented diagrammatically.

### DETAILED DESCRIPTION OF THE INVENTION

As illustrated in these figures, the monitoring beacon 2 comprises a ground base 4, into which a telescopic mast 6 is inserted. A detection head 8 is mounted on the end of the mast. The beacon also has solar panel support structures 10.

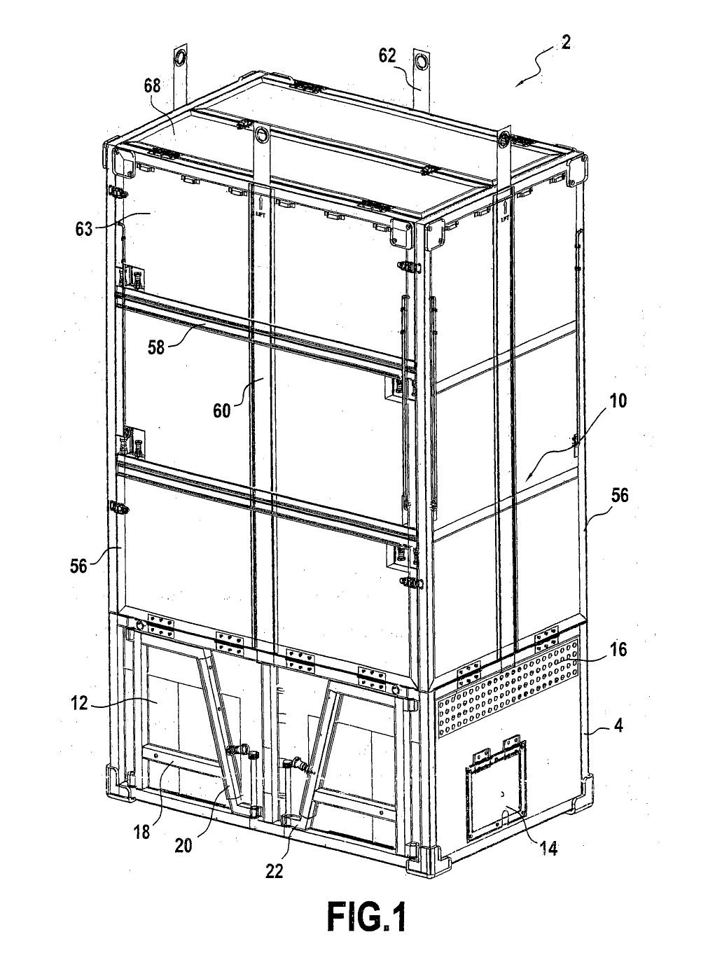

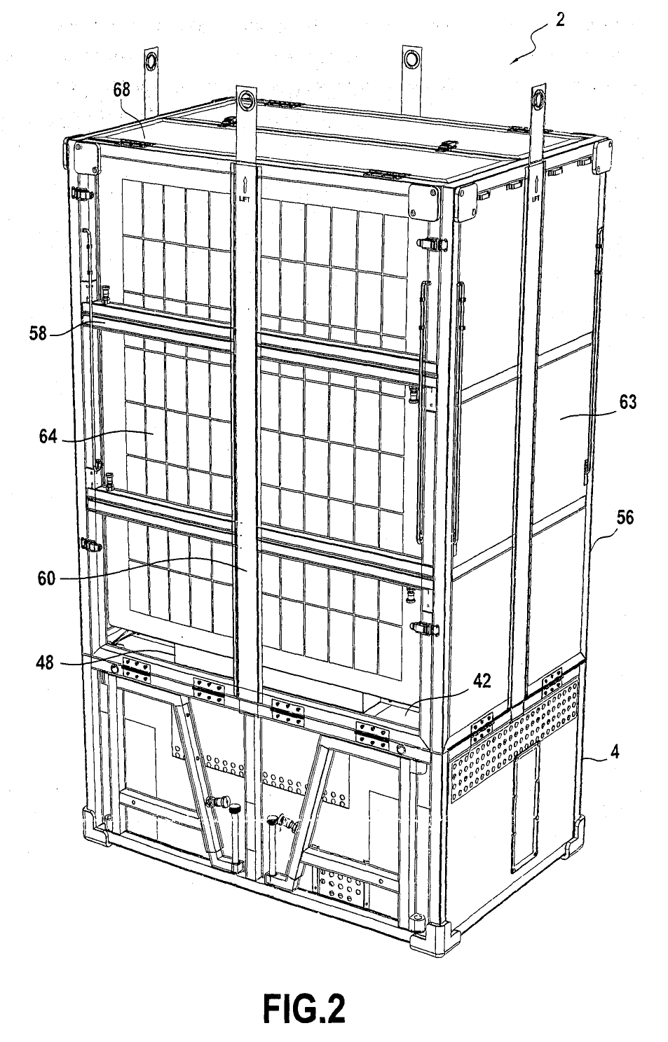

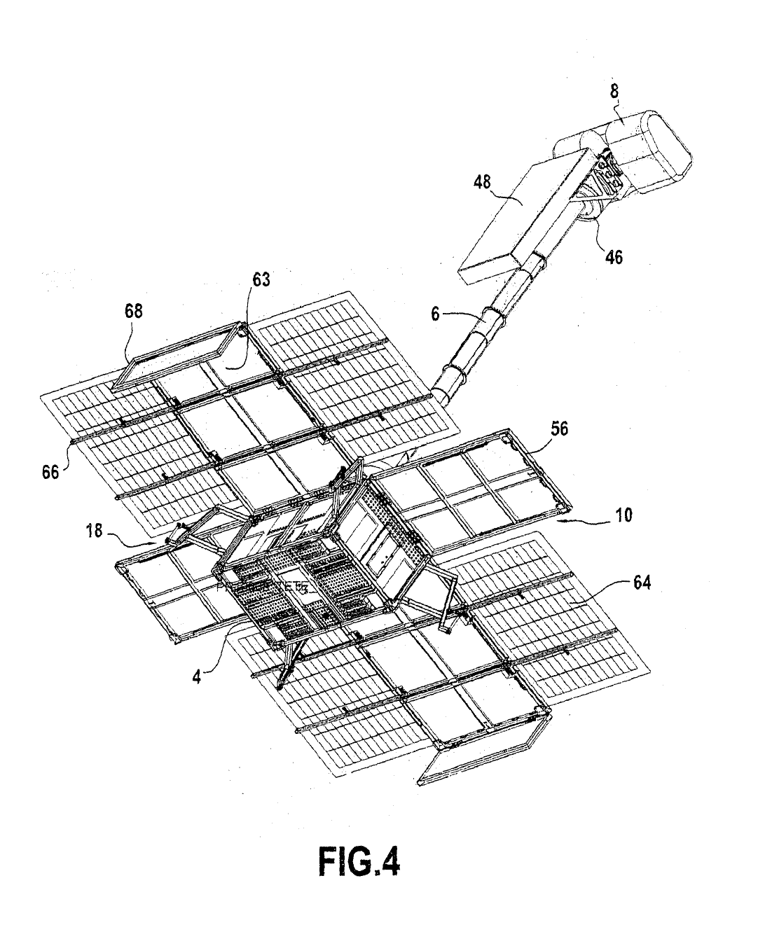

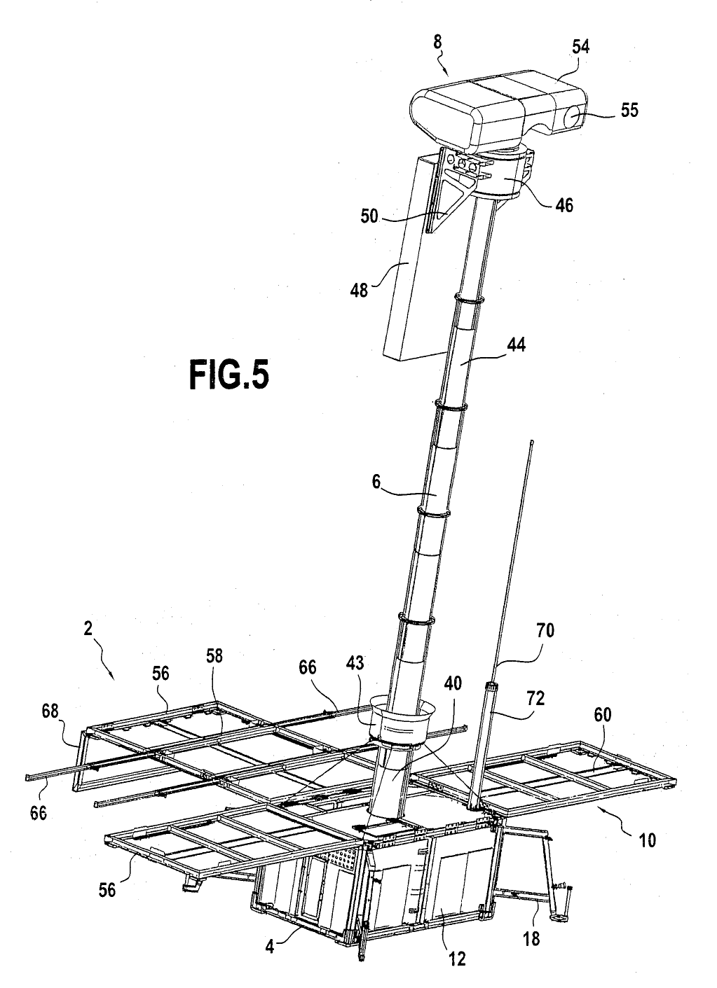

The beacon is designed such that in transport position (see FIGS. 1 to 3), the support structures form a protective cage, and in operating position (see FIGS. 4 and 5) the support structures are folded down flat and arranged horizontally around the base so that the mast and its detection head are no longer enclosed.

In the beacon transport position, the support structures are raised vertically to form a protective cage and the mast is retracted so that the head is completely inside the protective cage. In the beacon operating position, the mast is in extended position and the support structures are folded down flat.

The ground base 4 forms a rectangular case, open above and comprising four side panels 12 and a bottom panel. Doors 14 to provide access to the inside of the base and ventilation grilles 16 are located on the smaller sides. Four legs 18 are added to the larger sides, each comprising a support 20 mounted pivotably on one side so that it can be folded flat against the side of the base in transport position (FIGS. 1 to 3) and extended beyond the base (FIGS. 4 and 5) in operating position to ensure stability of the beacon. Each leg has an adjustable rod 22 designed to slide inside a hollow component of the support formed on the opposite side of the hinge pin connecting the leg to the base, and means are provided to prevent the rod from moving in translation with respect to the hollow component.

The ground base houses electronic components including batteries 24, an electronics box 26 containing analyzers and communication network management tools, a box 28 containing equipment designed to transform and collect energy from solar collectors, an air tank 30 and a compressor 32 for extension of the telescopic mast, an optoelectronic processing module 34 designed to process the three-dimensional image, a VHF transmission box 36 for low bandwidth exchanges and a UHF transmitter for high bandwidth communications, as well as man-machine interface equipment 38. The beacon is also advantageously equipped with a fuel cell which provides energy when there is insufficient sunlight.

These various components are arranged in the base, around a shaft 40 fixed to and extending vertically from the bottom of the base. Casing 42, placed on top of the base to form an upper wall to protect the electronic components, comprises two half-casings cut out to surround the shaft. The inside surface of the casing advantageously has insulating foam for better protection of the electronic components.

The telescopic mast is formed by said fixed shaft, at the upper end 10 of which there is a funnel 43, and extension rods 44 inserted one into the other, each being designed to be extended in relation to the one in which it is inserted.

At the free end of the smallest diameter extension rod, there is a turret 46 which supports both a mobile antenna 48 and the detection head 8.

The turret is mounted pivotably with respect to the axis of deployment of the telescopic mast. It comprises a cylindrical casing of circular cross-section on the outside of which brackets 50 are fixed to support the mobile antenna, which is thus made rotationally solid with the turret. The turret casing encloses the motorized equipment required to enable rotation of the antenna via the turret in response to instructions from electronic components that are sent from the base via electrical cables inside the smallest diameter extension rod. The turret also supports the detection head, mounted with two degrees of rotating freedom by means of hinges 52 at the top of the turret, opposite the mast. All the hinges are mounted pivotably around the axis of deployment of the telescopic mast, so that the detection head can turn 360° and a transverse pin 53 is designed to direct the detection head upwards or downwards.

The detection head has protective housing 54 inside of which there is a video camera, an intensive lighting device to light up the area to be filmed, a laser rangefinder, a north seeker and a satellite location system. The housing has a glass portion 55 to allow said videos and measurements to be taken.

As described above, the telescopic mast is designed to be placed in operating position, with the extension rods forming the mast either extended or retracted. The operating position is made possible by folding down the support structures prior to use. The beacon is then fully operational for both detecting intruders and communicating with the monitoring unit because the detection head and the mobile antenna are no longer enclosed. Retraction of the mast and the resulting retraction of the head provide a transport position for the beacon in which the support structures 10 are extended vertically to form the protective cage.

Each support structure has a frame 56 hinged to the top of one side of the ground base and comprises tracks 58 and a slide 60. The tracks extend perpendicular to the frame and parallel to the hinge axis of the frame. The slide is a U-channel designed to take a lift strap 62 to facilitate handling of the beacon.

A cover plate 63 is placed against the frame on one side of the support structure, and a solar panel 64 is placed on the opposite side of the structure. Advantageously, three solar panels are placed one on top of the other on the support structures of the two opposite larger sides.

The frame of the structure is hinged so that it can go from the vertical position in which the cover plate faces away from the beacon to form a wall of the protective cage, to a flat folded position in which the solar panels 64, placed against the frame on the side facing the beacon when the beacon is in transport position, are exposed to the light for the acquisition of solar energy and to supply the beacon with power via the solar energy transformation equipment inside the ground base.

The support structures on the two larger opposite sides have special horizontal tracks with telescopic elements 66 designed to be extended laterally beyond the frame in the extension of the corresponding horizontal track. As can be seen in FIGS. 4 and 5, and especially in FIG. 5 in which the solar panels are cut away, the horizontal tracks have two sets of telescopic elements so that they can be extended on either side of the frame. A larger solar panel support surface is thus formed designed to take the three solar panels after they have been unstacked.

On said two opposite sides, the support structure also has a flap 68 hinged to the frame, at the end opposite the ground base. In the beacon transport position, the two flaps are folded inwards to form the top of the protective cage.

The flat position of the structures is obtained when the hinges between the frame and the corresponding edge of the ground base are in their maximum open position. Furthermore, the hinged flaps, mounted in free rotation with respect to the frame, are designed to rest on the ground when the structures are in the flat position and form struts that relieve the hinges of the weight of the structure and the solar panels.

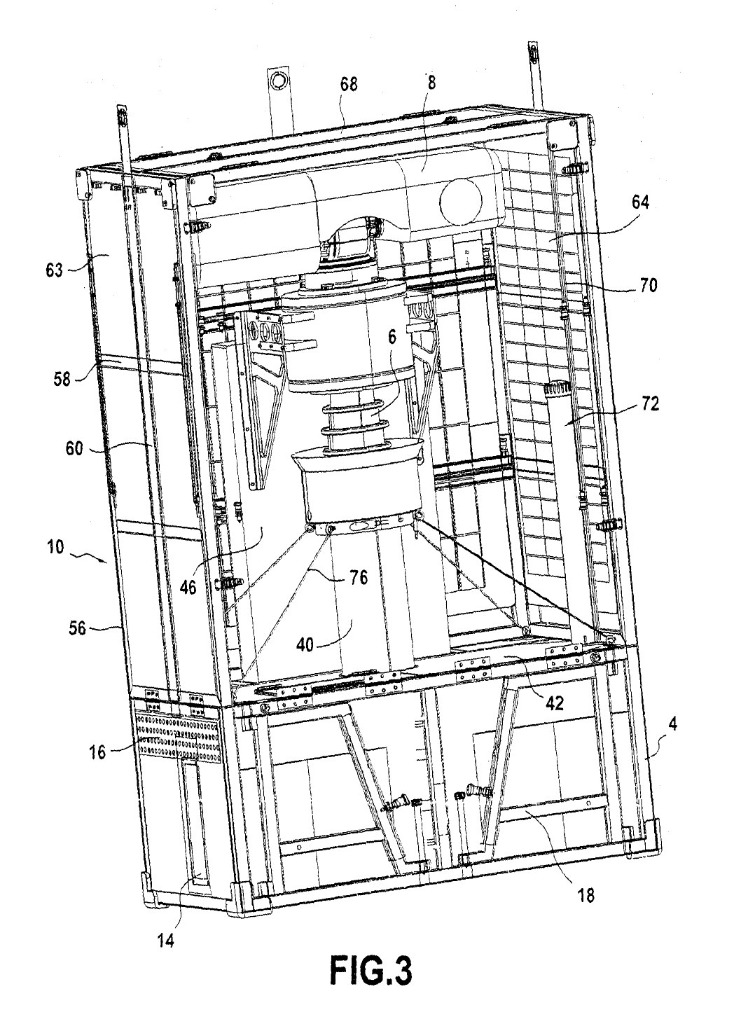

A fixed antenna 70 is attached to the ground base by means of a bracket. The fixed antenna here is a rod antenna which extends vertically above an antenna body 72 and the antenna rod has an axial dimension which is less than the height of the structures forming the walls of the protective cage when the beacon is in the transport position. The antenna rod can thus be kept inside the protective cage (as seen in FIG. 3) and easily screwed to the body to extend sufficiently beyond the base for transmission in the beacon operating position (as seen in FIG. 5).

We are now going to describe operation of the beacon according to the invention.

The beacons are loaded on a vehicle and each is taken to a location determined by a monitoring unit and its network configuration tool. A beacon is then lifted up by a transfer arm to which an operator has previously attached the lift straps.

Once the base has been set down on the ground and the straps have been unhooked, the operator opens up the legs. The operator can slide the adjustable rods along the hollow support of each leg, so that the end of said rods is in contact with the ground, to ensure stability and horizontality of the assembly. The operator then locks the rod in final position.

Advantageously, the operator can adjust the sliding position of the rods in the hollow support of each leg so that the beacon will remain horizontal even if the terrain is not flat. A level could be incorporated into the ground base to check that the beacon is in the horizontal position.

The operator opens each of the clasps that hold the support structures in place, first releasing the smaller side structures, then releasing the larger side structures which are held in place at the top of the beacon by the closed position of the flaps.

The structures are folded down flat and locked into position by the hinge stops. Because the base is already horizontal, the structures and the solar panels they support are also placed horizontally which is particularly important for maintaining optimum light reflection on the panels. The operator opens up the flap at the end of the support structures so that it rests on the ground (FIG. 5).

It can then be observed that when the support structures are folded down flat, the mast 15 can be extended and the communication equipment is operational.

Once the structures have been folded down flat, the operator slides the telescopic tracks on each side of the larger side structures to form additional support structures. The operator then removes the three solar panels from each of the larger structures and places the top two panels on each of the additional structures. This gives a total of eight solar panels, distributed evenly around the mast. The physical arrangement of the solar cells and their connection in series are especially designed so that the shadow cast by the mast does not interfere with solar energy production.

The beacon unpacking operations are now completed and the beacon is in operating position with an extended telescopic mast that carries a mobile antenna and a detection head and an additional fixed antenna. In this position, the inside of the ground base and the electronic components contained therein are protected.

During monitoring operations, the mast and detection head may need to be retracted either to make the beacon less visible or for safety reasons due to poor weather conditions, for example, in which case the beacon can be provided with an anemometer for detection purposes. In this case, it can be observed that the mobile antenna is located partly inside the base, in a recess 74 provided for this purpose. A capacitive proximity sensor 75 is placed near the recess to supply information relating to the presence of the mobile antenna in the recess. The telescopic movements of the mast generate stresses on the mast in both directions which are transferred to cables 76 connecting the funnel 43 to the four corners of the base.

Advantageously, the fixed antenna continuously transmits data on its position, for example, multidirectionally, so that the monitoring unit receives the data and processes it in real time using its network configuration tool. When the beacon detects an intruder, it is the fixed antenna that transmits the raw detection data. Simultaneously, the data generates the acquisition of complementary images of the area corresponding to the appearance of the potential intruder by means of video cameras in the detection head, and it also generates the orientation of the high electromagnetic gain directional mobile antenna towards the monitoring unit required to send the acquired images.

Mounting of the antenna on the turret enables the antenna to turn independently of the orientation of the head so that it can remain pointed towards the area to be monitored while the antenna is turning.

Triggering of the antenna on demand saves energy. Sending video data via the mobile antenna requires more energy resources than sending text data via the fixed antenna, which makes it particularly advantageous to trigger data transmission by the mobile antenna only when a potential intrusion is detected.

The beacons are arranged to form a network so that a given area can be fully monitored. The network configuration is initially determined by a calculation tool in the monitoring unit and a location is assigned to each of the beacons. Depending on the data exchanged continuously between each beacon, by means of its fixed antenna, and the monitoring unit, the network configuration can evolve in real time, that is, the position of the beacons can be changed, particularly those that have not yet been installed and are still onboard the vehicle; the operating mode of the detectors associated with each beacon can be changed remotely.

In particular, when setting up a network of beacons in mountainous areas where the perspective is not linear, the beacons can be recalibrated when they are installed on the ground to ensure ongoing coherency of the detection criteria on which the beacon's 3D-image processing system is based, and which refer to the theoretical mapping data. The laser telemeter is used to point at a reference point on the landscape and communicate the distance between the beacon and the reference point to the monitoring unit via the antenna. The monitoring unit uses the reference point to determine whether the detection criteria need to be changed or, for instance, the size of the pixels to be detected on the images.

The network layout is particularly useful when a beacon has detected a potential intruder at night or in the presence of fog. Active imaging of the area is then recommended; this consists in taking video films in conjunction with the use of an intense lighting device. According to the invention, the capabilities of several beacons are pooled so that intense lighting is provided by one or several beacons while the filming is carried out by another beacon. The monitoring unit receives information on a possible intrusion and the existence of reduced visibility via light sensors onboard the beacon, for example. The surface area in which the intrusion has been detected is estimated by the laser telemeter of the beacon that detected the intrusion. The information is sent to the beacons either directly or by the monitoring unit, via the fixed antenna, and the neighboring beacons turn on their lighting devices in order to intensely light up the area thus determined. Active imagery is thus performed without the need for fine time synchronization operations which would be necessary if the lighting device and camera were on the same beacon.

After perusal of the above, it is easy to see that the invention meets its objectives and that no further mention of this will be necessary. In particular, the invention enables a monitoring network to be produced using several redundant viewpoints whose configuration can be changed during the mission, using easy-to-display monitoring beacons with their autonomous power supplies designed to communicate with each other and a network monitoring unit, in an optimized manner with respect to said power supplies while achieving optimum detection. The facility with which the beacon can go from a transport position which is perfectly safe for the integrity of the components, particularly due to the presence of cover plates protecting the solar panels, to a fully operational position means that said beacon can be used in a monitoring network with a modular configuration that can be rapidly set up by operators with minimum skills. Furthermore, not using a DC power supply for the mobile antennas increases the autonomy of the beacon which is optimized by the large surface area of the solar panels exposed to sunlight. This is obtained by reducing the volume of the beacon during transport so that several beacons can easily be transported during installation of the monitoring network at various points in the site to be monitored.

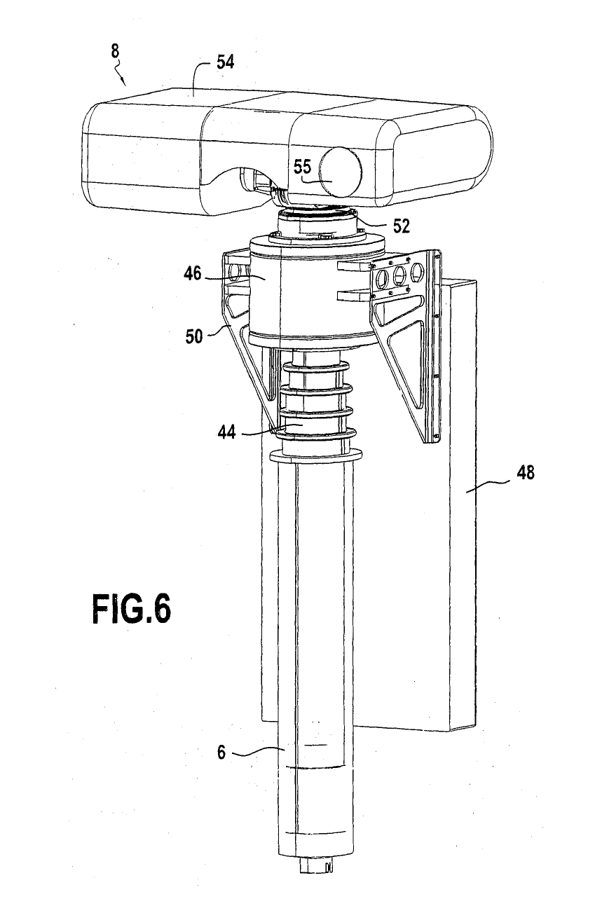

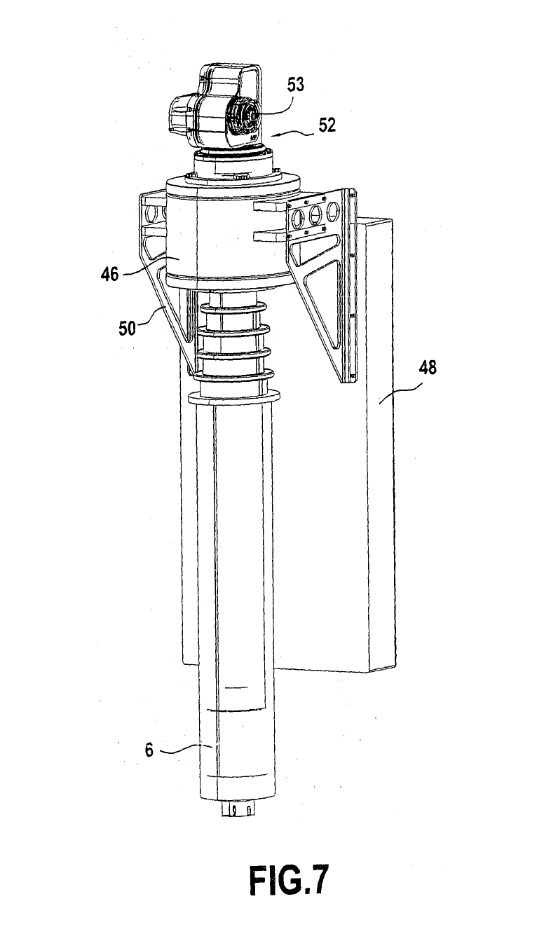

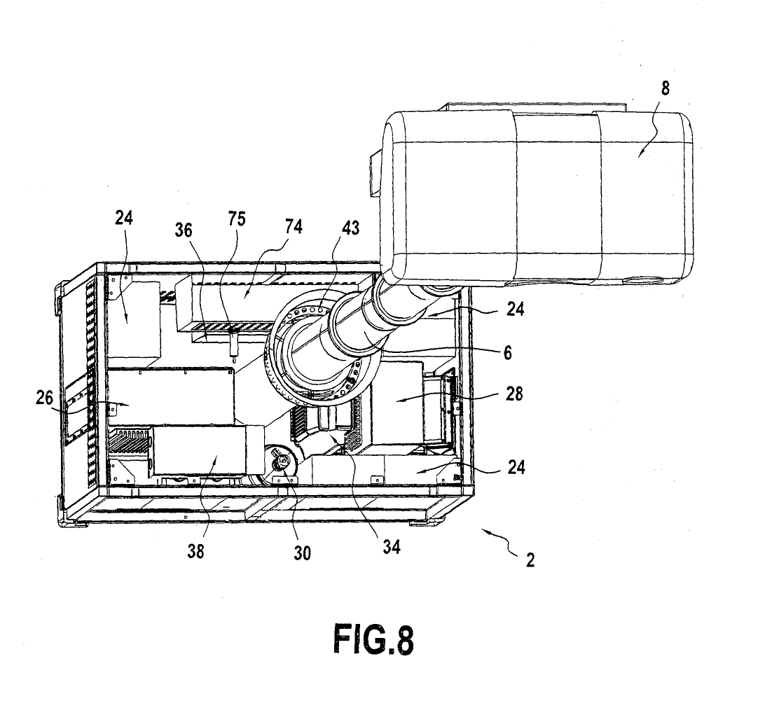

It is understood that the invention is not limited to the construction method explicitly described with respect to FIGS. 1 to 8, nor to the preferred application relating to use of the beacons in a network designed to monitor a mountainous border area. Without going outside the framework of the invention, the system applies to any type of monitoring system in which the mobility and discretion of the beacon according to the invention are advantageous. Likewise, the beacon could present variants, for example, in the number and functionality of the electronic components present.

1. A monitoring beacon comprising a ground base into which a telescopic mast is inserted, and an intrusion detection head mounted on an outer end of said mast, with solar panel support structures being pivotably mounted on the ground base and said beacon being designed to take up either a transport position in which said panel support structures are raised to form a cage to protect the beacon, or an operating position, in which said panel support structures are folded down flat around the base so that the mast and said detection head are no longer enclosed.

2. The beacon according to claim 1, further comprising communication equipment communicating with the monitoring unit including a mobile antenna which sits on top of the telescopic mast via a turret mounted rotationally around said mast, and wherein said detection head is hinged to the end of the mast independently of said mobile antenna.

3. The beacon according to claim 2, wherein the mobile antenna extends alongside the telescopic mast, a recess being provided in said ground base house part of the mobile antenna when the mast is retracted.

4. The beacon according to claim 3, wherein the communication equipment also has a fixed antenna designed to continuously transmit and receive communication data to and from the monitoring unit while the mobile antenna is only activated according to said data.

5. The beacon according to claim 1, further comprising legs hinged to the base, each of which has an adjustable rod to ensure that the base is kept in a horizontal position.

6. The beacon according to claim 1, wherein each support structure has a cover plate such that, in the beacon operating position, the solar panels are arranged on top of the structure with the cover plate underneath the structure, while in the beacon transport position, the solar panels are facing towards the beacon and the cover plate is facing away from the beacon.

7. The beacon according to claim 6, wherein solar panels are stacked on a given support structure and said given support structure comprises extendable elements on either side of the structure when it is folded down, to provide additional structures for each of the initially stacked solar panels.

8. The beacon according to claim 6, wherein the support structure on the two opposite sides of said beacon has a hinged flat on the end opposite the ground base which forms a strut when the support structure is folded down, and is part of the top on the protective cage when the support structure is raised vertically.

9. A network of monitoring beacons each of which comprises a ground base, a detection head mounted on an outer end of a telescopic mast inserted into said base, communication equipment with a monitoring center, and solar panels hinged to said base, in which the head has a video camera and an intense lighting device, and in which the camera in one of the beacons in the network is used simultaneously with the intense lighting device in another beacon in the network, with both beacons being directed towards the same monitoring zone.
